(19) United States
(12) Patent Application Publication
(10) Pub. No.: US 2006/0112584 A1
(43) Pub. Date: Jun. 1, 2006

(54) Dehydration of food combinations

(76) Inventor: Ken Jones, Lacey, WA (US)

Correspondence Address: SWANSON & BRATSCHUN L.L.C., 1745 SHEA CENTER DRIVE, SUITE 330, HIGHLANDS RANCH, CO, 80129, US

(21) Appl. No.: 11/286,253

(22) Filed: Nov. 23, 2005

Related U.S. Application Data
(60) Provisional application No. 60/631,736, filed on Nov. 29, 2004.

(51) Int. Cl. F26B 19/00; F26B 7/00

(52) U.S. Cl. 34/60; 34/418

(57) ABSTRACT

A method producing a homogeneous dried material from a mixture of foods, food extracts, herbs, herb extracts, or supplements is provided.

### CROSS-REFERENCE TO RELATED APPLICATIONS

This application claims the benefit, under 35 U.S.C. § 119, of U.S. Patent Application Ser. No. 60/631,736, entitled “Dehydration of Food Combinations,” filed Nov. 29, 2004.

### FIELD OF THE INVENTION

The invention relates to the drying of blends of aloe, foods or food extracts, herbs or herb extracts, nutritional supplements, and the like.

### BACKGROUND OF THE INVENTION

Drying of foods as a means of preservation has a long history. Drying technologies in place today include spray drying, tray drying, freeze drying, osmotic dehydration, fluid bed drying, flash drying, sprouted bed draying, drum drying and infrared drying. Many factors are considered in choosing a technology for drying, including desired quality cost of the process. Spray dryers, fluid bed dryers and roller dryers are often used for drying liquids, slurries and purees, for example. Newer developments in dehydration technology include high vacuum drying, microwave drying, radio wave drying, and so called “refractance window” drying, which is effected by providing heat transfer between a body of liquid and a product.

Additional considerations must be taken into account in the drying of combinations of foods or food extracts. For example, if spray drying is to be used, the combination must be filtered to remove components that can not be liquefied, such as skins. Even if combinations are homogeneous as liquids, the combination after drying may have a non-homogeneous particle size or density, which leads to a non-homogeneous powder. Dry blends of powders containing different combinations of food, herbs, supplements or extracts of food or herbs can experience separation of constituents due to different densities even when particle size is similar. Accordingly, methods for drying combinations of foods and related products are needed.

### SUMMARY OF THE INVENTION

The present invention provides a method of drying a product of two or more items comprising the steps of positioning a sheet of optically and infrared transparent material on a body of water so that a first surface of the sheet is in substantially uniform contact with an upper surface of the water and the sheet is supported by the buoyant force of the water; heating the water to maintain the water at a predetermined temperature; and placing the product to be dried on a second surface of the sheet, wherein the product comprises two or more items selected from the group consisting of foods, food extracts, herbs, herb extracts, vitamins, and nutritional supplements, whereby a dried product is produced. In some embodiments, one of the items comprising the product to be dried is derived from aloe.

The present invention also provides a dried product produced by the method of claim 1. In some embodiments, the ratio of the components in the product to be dried is retained throughout the dried product.

The present invention also provides a homogeneous composition comprising dried aloe and at least one items selected from the group consisting of foods, food extracts, herbs, herb extracts, vitamins, and supplements. In some embodiments, the homogeneity of the composition is retained for at least about three years.

### DETAILED DESCRIPTION OF THE INVENTION

The present invention provides methods for the production of a composition of two or more dehydrated foods or food extracts, herbs or herb extracts, supplements. In some embodiments, the aloe is one of the components utilized in the method. The term “Aloe” refers to the genus of South African plants of the Liliaceae family. Representative species include Aloe arborescens, Aloe barbadensis, Aloe cremnophila, Aloe ferox, Aloe saponaria, Aloe vera, and Aloe vera var. chinensis. The term “Aloe extract” refers to a preparation obtained from an Aloe plant by chemical or mechanical action, as by pressure, distillation, or evaporation. Examples of Aloe extracts include the juice of the whole leaf of various species of the Aloe plant, and the “fillet” of the leaf (rind has been removed). The present invention also provides dehydrated compositions prepared by the methods of the invention.

The drying method employed in the present invention utilizes the so-called “refractance window” method. In this method, the transfer of heat from a heated medium to the food product to be dried is accomplished by floating a film of transparent material on a body of water, heating the water to maintain the water at a predetermined temperature, and placing the product to be dried on the floating film. In order to carry out this method, an apparatus is provided that includes a reservoir of water and means associated with the reservoir of water for heating the water to the predetermined temperature and maintaining the reservoir of water at that predetermined temperature. A transparent, solid film is floated on the surface of the heated water and is adapted to receive the material to be dried. This drying technology is described in detail in U.S. Pat. No. 4,631,837, entitled “Method and Apparatus for Drying Fruit Pulp and the Like,” and incorporated by reference herein in its entirety. In ordinary use, the invention the floating material can be a flexible plastic and can be arranged on a conveyor system so that it moves across the reservoir of water carrying the pulp from a loading station to a removal station with the timing of the conveyor belt and the parameters of the product being applied to the conveyor belt being such that the product is applied in a colloidal suspension of solid particles in a liquid base at one end of the conveyor and removed in its dried state at the second end of the conveyor. The carrier is transparent to infrared radiation and able to withstand temperatures in the range of the boiling point of water without shrinkage or deterioration of the material.

It has been found that utilization of the above-mentioned method with combinations of products results in a dehydrated composition that is homogeneous and resistant to separation of the components. That is, the ratio of the components is retained in the dried product. The method produces a dehydrated product with a density similar to that obtained by spray-drying, but with a retention in heat-labile constituents similar to that obtained via freeze-drying.

Products which may be utilized in the combinations for drying include but are not limited to berries, fruits, herbs, vegetables, vitamins, nuts, legumes, grains and extracts or purified extracts of berries, fruits, herbs, vegetables, vitamins, nuts, legumes or grains including but not limited to aloe, apple, crabapple, Chokeberry, Hawthorn, Juneberry, Saskatoon, Loquat, Medlar, Pomegranate, Pear (European and Asian species), Quince, Rowan, Service tree, Rose hip, Apricot, Cherry (sweet, sour and wild species), Plum, Peach and hybrids of the preceding species; Blackberry, boysenberry, Loganberry, Cloudberry, Wineberry, Bearberry, Bilberry, Whortleberry, Blueberry, Cranberry, Huckleberry, Lingonberry, Barberry, Currant, Elderberry, Gooseberry, Honeysuckle, Honeyberry, Nannyberry, Sheepberry, Sea-buckthorn, Wolfberry, Crowberry, Mulberry, Goumi, Kiwi fruit, Persimmon, Buffaloberry, Pawpaw, Prickly pear, Saguaro, Pitaya, Melon, Cantaloupe, Sunberry, Wonderberry, Watermelon, Strawberry, Angelica, Rhubarb, Cornelian cherry, Fig, Grape, raisin, sultana, Jujube, Black mulberry, Date palm, Citron, Grapefruit, Key Lime, Kumquat, Lemon, Lime, Mandarin, Clementine, Tangelo, Orange, Ugli fruit, Guava, Longan, Lychee, Passion fruit, Feijoa, Akee, Banana, Breadfruit, Burmese grape, CamuCamu, Carambola, Cempedak, Cherimoya, Coconut, Custard apple, Dragonfruit, Durian, Guarana, Jackfruit, Keppel fruit, Langsat, Mabolo, Mamey sapote, Mamoncillo, Mango, Mangosteen, Marang, Papaya, Peanut butter fruit, Pineapple, Poha, Rambutan, Rose apple, Salak, Sapodilla, Soursop, Sugar apple, Tamarind, Alfalfa sprouts, Anise, Artichoke, Arugula, Asparagus, Aubergine, Eggplant, Avocado, Azuki beans, Bean sprouts, Black beans, Black-eyed peas, Borlotti beans, Broad beans, Chickpeas, Green beans, Kidney beans, Lentils, Lima bean, Mung beans, Navy beans, Runner beans, Soybeans or milk of soybeans, Peas, Mangetout, Bok Choy, Broccoflower, Broccoli, Brussel sprouts, Cabbage, Calabrese, Cauliflower, Celery, Chard, Cilantro, Collard greens, Corn salad, Endive, Fennel, Fiddleheads, Frisee, Kale, Kohirabi, lemon grass, Lettuce, Maize, Mushrooms, Mustard greens, Nettles, Okra, Chives, Garlic, Leek, Onion, Ramps (Wild leeks), Shallot, Spring onion, Scallion, Parsley, Peppers, Green pepper, Red pepper, Pimento, Chili pepper, Jalapeno, Habanero, Paprika, Tabasco, Cayenne pepper, Radicchio, Rapini, Beetroot, Beet, Mangel-wurzel, Carrot, Cassaya, Celeriac, Daikon, Fennel, Ginger, Parsnip, Radish, Rutabaga, Turnip, Wasabi, White radish, Salsify, Purple Salsify, Skirret, Spinach, Acorn squash, Butternut squash, Courgette, Zucchini, Cucumber, Gem squash, Squash, Patty pans, Pumpkin, Spaghetti squash, Tat soi, Tomato, Jicama, Jerusalem artichoke, Potato, Sweet potato, Taro, Yam Water chestnut, Watercress, Wheat, Rice or milk of rice, Sorghum, Rye, Triticale, Oats, Barley, Teff, Wild rice, Spelt, Amaranth, Buckwheat, Quinoa, Basil, Bay leaves, Chervil, Cilantro, Dill, Fiddlehead Fern, Marhoram, Mint, Oregano, Parsley, Rosemary, Sage, Savory, Sorrel, Tarragon, Thyme, Echinacea, Goldenseal, Horehound, Wormwood, Sweet sagewort, Crataegus, Digitalis purpurea, foxglove, St. John's Wort, Chamomile, Catnip, Passion-flower, Plantain, Psyllium, Comfrey, Feverfew, Dandelion, Lime Blossom, Valerian, Black Cohosh, Black willow, Chamomile, Coriander, Chaparral, Dandelion, Dong Quai, Elderberry flowers, Ginseng, Gotu Kola, Hops, Germander, Gingko, Horehound, Monardo, Lavender, Lemon balm, Lobelia, Mullein, Passionflower, Peppermint, Primrose, Red Clover, Red Reishi, Purple Willow, Raspberry, Rue, Sallow, Skullcap, Squaw vine, Taheebo, Yarrow, Soapwort, Stevia, Tansy, White willow, Willow, Calamondin, Citrangequat, Collard, Sweet corn, Grape seed, Grapefruit, Grapefruit seed, Mustard, Pecan, Pummelo, Turnip, Green tea, Kava kava, valerian, saw palmetto, vitex, flax, minerals, dairy products, natural or synthetic sweeteners, natural or artificial flavorings, honey, chicory root, noni, nopal, ginkgo biloba, acerola, astragalus, atractylodes, avena sativa, bayberry, bitter melon, black cohash, blue cohash, borage, boswellia, burdock, butcher's broom, cascara sagrada, cat's claw, cedar berrie, chasteberry, chickweed, Chinese dodder, cinnamon, cranberries, damiana, dang shen, devil's claw, dodder, elder flowers, elecampane, ephedra sinicia, eucalyptus, eocommia, evening primrose oil, eyebright, false Unicom, true Unicom, fenugreek, feverview, flax seed, forskohilii root extract, fo-ti (he shou wu), grape skin extract, griffonia, gymnema, hibiscus, horse chestnut, horseradish, horsetail, hydrangea, hyssop, juniper, kelp, kola nut, kombucha, Korean ginseng, kudzu, lemon peel, lemongrass, licorice, ligusticum, ligustram, linden, ling chih, lung wort, lycil, maca, maitake, marigold, marshmallow, Melissa, milk thistle, motherwort, muria puama root, myrrh, myrtle, neem, nutmeg, oatstraw, orchid, Oregon grape root, paeonia, pai shu, parsely, passion flower, pau d arco, penny royal, peony, periwinkle, pine, pine bark, piper nigron, pleurisy, polygala, polyporus (fu ling), poria, prairie dock, prane, pureariae, pullulan, pussywillow, pygeum, queen of the meadow, red cabbage, red raspberry, red root, red wine, rehmannia, rhodiola rosea, rice bran, rose, sabadilla, saffron, salviae, sarsaparilla, saussurea, schisandra, skullcap, scutellariae, sea vegetable, senna, serenoa serrulata, shark, shen min, shitake, Siberian ginseng, silymaria, slippery elm, solidago virgaurea, spearmint, suma, sunflower, tangerine, tea tree, tribulus, tumeric, urtica dioica, urtioa urens, Usnea, uva ursi, velvet bean, vervain, vijaysar, wheat germ, white oak, white peony, wild cherry, wild jam, wintergreen, witch hazel, wood betony, yellow dock, yerba mate, yucca, zedoary, and extracts, juices, or other preparations of the above.

Nutritional supplements suitable for use in the present invention include, but are not limited to: Vitamin A, Vitamin B1 (Thiamin), Vitamin B2 (Riboflavin), Vitamin B3 (Niacin), Vitamin B6 (Pyridoxine), Vitamin B12 (Cobalamine), Vitamin C, Vitamin D, Vitamin E, Calcium, Vitamin K, Folic acid, Biotin, Pantothenic Acid, Phosphorous, Iodine, Magnesium, Zinc, Selenium, Copper, Manganese, Chromium, N-acetyl cysteine (NAC), Sodium sulfate, Molybdenum, L-glutamine, L-threonine, L-lysine HCl, Citrulline, Hesperidin, Quercetin, Rutin, Curcumin, D-limonene, Creatine, carnitine, CoQ 10, L-isoleucine, catechins, Red grape skin, ginger, rosemary, protein, whey, other amino acids, beta-carotene, choline, iron, boron, potassium, colostrum, melatonin, alpha lipoic acid, arabinogalactan, astaxanthin, bee propolis, bee pollen, beta glucans, bovine cartilage, glucosamine, chondroitin, MSM, chitosan, CLA, DHA, DHEA, DMAE, bioflavonoids, flavonoids, hyaluronic acid, Indol-3 Carbinol, inositol, inulin, isoflavones, lecithin, lutein, lycopene, octacosanol, plant sterol/stanol esters, policosanol, polyphenols, prebiotics, probiotics, pyruvate, resveratrol, ribose, royal jelly, SAM-e, Theobromine, tocotrienol, vinpocetine, zeaxanthin, blue green algae, algae (various), chlorphyll, collagen, Green lip mussel, red yeast rice, xanthan, xylitol, PABA, fiber, sugar, oligosugars, polysaccharides, lipids, pulp from Aloe vera, 17 beta diol, 5-HTP, acetabolan, acidophilus, ambrotose, aspirin, caffeine, chlorella, chromium picolinate, chrysin, counterfeits, glycerol, kava kava, melanin, silymarin, spirulina, yohimbe, carotenoids, alfalfa, amylase, arachidonic acid, arginine, aspartic acid, beta sitosterol, betaine, bioperine, bromelain, cellulase, cryptoxanthin, cystine, EFA Complex, enzymes, EPA, fish oil, fructooligosaccharide, GABA, garcinia, genistein, GLA, glutamic acid, glutamine, glutathione, guggul, histadine, huperzia, inosine, isoleucine, lactase, lactobacillus, leucine, lenoleic acid, lenolenic acid, lipase, lysine, lysophospholipid, malic acid, methionine, oleic acid, orchic extract, omithine, oryzanol, pantethine, papain, pepsin, phenylalanine, phosphatidyl choline, phosphatidyl serine, phosphorus, phytosterol, pregnenolone, proline, protease, pycnogenol, soy, taurine, threonine, thymus extract, tryptophan, tyrosine, valine, and sulfur.

The listed fruits, berries, vegetables, herbs, nuts and grains or nutritional supplements or vitamins may be liquefied in any combination by any process, filtered or unfiltered, with or without skins, hulls, seeds and combined. In some embodiments, the component is combined with aloe in a ratio of less than 1% to greater than 99% in the liquid form. Extracts of any constituent of the listed fruits, berries, vegetables, herbs, nuts and grains may be liquefied by any process, filtered or unfiltered and combined. In some embodiment, the extracts are combined with aloe in a ratio of less than 1% to greater than 99% in the liquid form. The liquid combinations are then dried using the methods of the invention to form a gel, a film, a flake, or a powder that retains the original homogeneity of the liquid. The form of the dried product depends on several factors, such as composition of original components, temperature of drying, residence time on the dryer, moisture content of the product, and polysaccharide content of the product. For example, products with higher polysaccharide content tend to result in more filmlike products. In some embodiments of the invention, the form of the dried product may be controlled by controlling the above-mentioned factors. For example, if a film is desired, then polysaccharide may be added to the liquid composition. Films may be converted to flakes or powders, and flakes may be converted to powders with further processing of the dried product.

Homogeneity of the product may be determined by methods known to those skilled in the art. It is known in the art that dry blends containing different combinations of food, herbs, supplements or extracts of food or herbs can experience separation of constituents due to different densities even when particle size is similar. Such separations occur, for example, during transport of the mixtures. The present combinations of dried blends, however, do not undergo a separation of constituents under these circumstances. In some embodiments, the homogeneity of the dried product is retained for at least about three years.

The dried blends of the present invention can be used in a variety of applications. Combinations of berries, fruits, herbs, vegetables, vitamins, nuts, legumes, grains and extracts or purified extracts of berries, fruits, herbs, vegetables, vitamins, nuts, legumes or grains with aloe that remain homogeneous in dehydrated form will improve the ease of formulations and standardize the constituents of the product. Standardization of constituents will improve the dependability of sensory attributes, nutrients and bioactivities of the combinations. Bioavailability of nutrients may be improved in the presence of aloe and the nutritional value of the foods, supplements or extracts. The dried products may be reconstituted with water. The dried blends can be used as a preformulation for the preparation of food, supplemental, therapeutic or cosmetic products. For example, a dried composition of aloe, blueberry, and sweetener can be used in the preparation of a sweetened beverage. As another example, a blended dried composition comprising aloe can be added to further ingredients in a dry blending process in preparation of a final product such as a foodstuff, capsule, and so forth. Another dried composition included in the present invention is a dried composition of aloe, blueberry, cranberry and raspberry.

As to the preparation of capsules of the dried blends, for example, as nutritional supplements, the dried blends of the present invention are suitable for use in an encapsulation process since they are homogeneous and would not encounter difficulties with ingredient flow that may be present in nonhomogeneous mixtures.

The dried blends of the present invention may be used in compositions for various uses, such as therapeutic, cosmetic, and nutritional uses. For example, the dried blends may be formulated in a composition that contain a therapeutic agent. The therapeutic agent may be present either as part of the dried blend, or as part of a further composition. Aloe may be used for therapeutic applications in the treatment of psoriasis and other skin disorders. Reference herein to an animal or patient refers to a human or other mammal.

For topical application to the skin or mucus membranes of the nose and throat, including the nasopharynx, the active ingredient(s) may be made up into a cream, lotion, ointment, sprays or inhalants, lozenges, throat paints, dentifrices, powders, encapsulated in micelles or liposomes and drug release capsules including the active compounds incorporated within a biocompatible coating designed for slow-release, and mouthwashes and other washes. Formulations which may be used are conventional formulations well known in the art, for example as described in standard textbooks of pharmaceutics such as the United States Pharmacopoeia (USP), British Pharmacopoeia, European Pharmacopoeia, Japanese Pharmacopoeia, and International Pharmacopoeia. Formulations of the present invention can include, for example, components such as a pharmaceutically acceptable excipient, an adjuvant, and/or a carrier. For example, compositions of the present invention can be formulated in an excipient that the animal to be treated can tolerate. Examples of such excipients include water, saline, Ringer's solution, dextrose solution, mannitol, Hank's solution, and other aqueous physiologically balanced salt solutions. Nonaqueous vehicles, such as fixed oils, sesame oil, ethyl oleate, or triglycerides may also be used. Other useful formulations include suspensions containing viscosity enhancing agents, such as sodium carboxymethylcellulose, sorbitol, or dextran. Excipients can also contain minor amounts of additives, such as substances that enhance isotonicity and chemical stability. Examples of buffers include phosphate buffer, bicarbonate buffer, Tris buffer, histidine, citrate, and glycine, or mixtures thereof, while examples of preservatives include thimerosal, m- or o-cresol, formalin and benzyl alcohol. Standard formulations can either be liquid injectables or solids which can be taken up in a suitable liquid as a suspension or solution for injection. Thus, in a non-liquid formulation, the excipient can comprise dextrose, human serum albumin, preservatives, etc., to which sterile water or saline can be added prior to administration.

In the case of compositions of the present disclosure for topical application, either in a therapeutic or cosmetic application, the compositions may be presented, as, for instance, ointments, creams or lotions, eye and ear ointments, gels, skin patches, impregnated dressings and aerosols. The compositions may also contain appropriate conventional additives, for example preservatives, solvents to assist drug penetration (e.g., DMSO), emollients, local anesthetics, preservatives and buffering agents.

A suitable cream base may conveniently comprise an emulsifying system, for example, components such as sorbitan monostearate, Polysorbate 60, cetyl palmitate, paraffin, cetylstearyl alcohol, benzyl alcohol, silica, triacetin, isopropyl monostearate, polyethylene glycol, glycerol monostearate, polyacrylic acid, sodium hydroxide, docusate sodium, dimethicone, triglycerides, octyldecanol and octyldodecanol.

A suitable gel base may conveniently comprise a semi-solid system in which a liquid phase is constrained within a three dimensional polymeric matrix with a high degree of cross-linking. For example, the liquid phase may conveniently comprise water, together with water-miscible additives, for example glycerol, polyethylene glycol, or propylene glycol, and a thickening agent, which may be a natural product, for example tragacanth, pectin, carrageen, agar and alginic acid, or a synthetic or semi-synthetic compound, for example methylcellulose and carboxypolymethylene (carbopol); together with one or more preservatives, for example methyl 4-hydroxybenzoate (methyl paraben) or phenoxyethanol.

As noted above, the dried composition of the present invention can be present in various forms, including gels, films, flakes, and powders. The form of the dried composition will inform the addition of other components for a particular use. For example, it is possible to treat aloe enzymatically. When enzymatically-treated aloe is used as one component in a dried blend, the resulting product has the consistency of water. When the aloe is not treated enzymatically, the resulting product has the consistency of a gel. The gel may be used as is for topical application, e.g., as a moisturizer, or may used as a component in a further mixture. Such a composition would have applications as skin treatment for cosmetic or therapeutic use. As another example, a dried blend containing a aloe as one component that forms a thin film upon drying may be applied to gauze or a bandage for topical application. Such a film could also be applied to a backing to deposit an aloe-containing thin film onto the skin for therapeutic purposes, or for a cosmetic purpose.

If necessary the composition may be milled at any suitable stage of the process. A suitable sterilization procedure may also be included if necessary. Alternatively raw materials are obtained in sterile condition and the compositions are produced aseptically.

Generally, the therapeutic agents used in the disclosure are administered to a human or animal in an effective amount. Generally, an effective amount is an amount effective to either (1) reduce the symptoms of the disease sought to be treated or (2) induce a pharmacological change relevant to treating the disease sought to be treated. For bacterial infections, for example, an effective amount includes an amount effective to: reduce or eliminate the bacterial population; slow the spread of infection; or increase the life expectancy of the affected human or animal.

Therapeutically effective amounts of the therapeutic agents can be any amount or doses sufficient to bring about the desired effect and depend, in part, on the condition, type and location of the infection, the size and condition of the patient, as well as other factors readily known to those skilled in the art. The dosages can be given as a single dose, or as several doses, for example, divided over the course of several weeks.

Compositions may be applied topically both to the outer skin and to other parts of the human or animal body, for example the eyes and inside the nose. The compositions may also be applied topically to areas in which the skin is missing or damaged, as found, for example, in burns and wounds.

Thus, the present disclosure provides a method of treating skin disorders in human or domestic mammals, which method comprises applying topically to a human or domestic mammal in need thereof the composition.

Use of the present compositions may also be in food products, including those envisioned for use as a dietary supplement such as a health bar.

Beverage compositions using dried blends of the present invention may comprise a beverage member such as water, fruit juice, tea solids, milk solids, fruit flavors, botanical flavors, and mixtures thereof. Water may be included in the compositions of the present invention, particularly wherein the compositions are beverage compositions. As used herein, the term “water” includes the total amount of water present in the composition. “Water” includes water from flavor agents, sugar syrups, and other sources, e.g., gum solutions. The term “tea solids” as used herein means solids extracted from tea materials including those materials obtained from the genus Camellia including C. sinensis and C. assaimica, for instance, freshly gathered tea leaves, fresh green tea leaves that are dried immediately after gathering, fresh green tea leaves that have been heat treated before drying to inactivate any enzymes present, unfermented tea, instant green tea, and partially fermented tea leaves. Green tea materials are tea leaves, tea plant stems, and other plant materials that are related and which have not undergone substantial fermentation to create black teas. Members of other families of tea plants can also be used. Mixtures of unfermented and partially fermented teas can be used. Tea solids for use in beverages of the present invention can be obtained by known and conventional tea solid extraction methods. Tea solids may comprise caffeine, theobromine, proteins, amino acids, minerals and carbohydrates. A dried composition included in the present invention is a dried composition of aloe, tea or tea solids, ginseng, and Gingko.

Beverages according to the present invention may also comprise milk solids. These milk solids can be derived from various sources including whole milk, skim milk, condensed milk, and dried milk powder. As used herein, the term “milk” will be used to describe an aqueous dispersion of milk solids, such as fluid (whole or skim milk) or non-fat dry milk or condensed milk diluted with water.

Dietary foods can be made with the dried compositions to meet special dietary needs, for example, of persons who are obese, diabetic, or hypercholesterolemic. The present compositions can be used alone or in combination with drug therapy, nutritional therapy, or other therapy. Combinations of food or beverage products made with the compositions can be used as part of a total dietary management regimen, based on one or more of these products, containing the compositions alone or in combination with one or more of the above-mentioned ingredients, to provide one or more of the above-mentioned benefits.

### EXAMPLES

The following examples are provided for illustrative purposes only and are not intended to limit the scope of the invention.

### Example 1

Aloe feed stock. As previously described, aloe whole leaf or gel (fillet) may be used as the base for any different combination of berries, fruits, herbs, vegetables, vitamins, nuts, legumes, grains and extracts or purified extracts of berries, fruits, herbs, vegetables, vitamins, nuts, legumes or grains. The aloe may be concentrated by dehydration to approximately 17% solids or may be supplemented with high solids from a previously mentioned product to achieve 17% solids without dehydration of the aloe. The aloe may be filtered or not. Aloe filet or whole leaf can be ground without other processing to a slurry and combined with any combination of previously identified foods, supplements or extracts to a required concentration of solids for drying.

### Example 2

Combination of blueberry juice and aloe Commercial blueberry juice concentrate at 65° Brix are diluted with de-ionized water to obtain Brix levels of 17% solids and mixed in a 500-gallon tank with aloe juice concentrate at 17% solids at a ratio of 50/50. Aloe juice is prepared by one of two methods. Aloe gel is produced by the automated removal of the aloe rind, followed by treatment with cellulase enzyme for a prescribed time and temperature. The aloe is then filtered and the pulp removed. The aloe juice is then concentrated by partial dehydration to produce a 17% solids product. Whole leaf aloe is produced by exactly the same method except that the whole leaf is ground and filtered before concentration. An agitator bar in the mixing tank maintains the homogeneity of the blueberry/aloe mixture. The mixture is feed to the dryer at a rate of 0.3 gallons per minute. The speed of the dryer belt is adjusted to achieve approximately 3% remaining moisture in the dry product. The recovered dehydrated material is a homogeneous dried matrix of blue berry and aloe that has the same ratio of composition as the liquid juice combination. This ratio is maintained during storage and may be reconstituted in water to produce a liquid mixture identical to the feedstock before drying.

### Example 3

Combination of dried vitamin C and aloe Studies have shown that aloe can increase the bioavailability of both water (vitamin C) and fat (vitamin E) soluble vitamins. Other studies show that aloe can act as a biological vehicle for drug delivery. These unique properties of aloe can be utilized to improve the absorption of nutrients in foods and dietary supplements that are combined in the invention. The concentration of dietary supplements can be reduced in products combined with aloe when bioavailability is increased. Aloe contains calcium, potassium and magnesium which are know to improve nutrient absorption and calcium uptake. Additionally, drying via heat transfer between a body of liquid and a product has been shown to retain higher vitamin C (ascorbic acid), beta and alpha carotene than spray drying.

Vitamin C is diluted in aloe gel of approximately 17% solids to a concentration of 19.2 grams vitamin C per gallon of aloe gel and mixed in a 500-gallon tank. The homogeneity of the mixture is maintained by the constant mixing of an agitator bar in the tank. The mixture is feed to the dryer at a rate of 0.3 gallons per minute. The speed of the dryer belt is adjusted to achieve approximately 3% remaining moisture in the dry product. The recovered dehydrated material is a homogeneous dried matrix of vitamin C and aloe that has the same ratio of composition as the liquid juice combination. This ratio is maintained during storage and may be reconstituted in water to produce a liquid mixture identical to the feedstock before drying.

What is claimed is:

1. A method of drying a product of two or more items comprising the steps of:
(a) positioning a sheet of optically and infrared transparent material on a body of water so that a first surface of the sheet is in substantially uniform contact with an upper surface of the water and the sheet is supported by the buoyant force of the water;
(b) heating the water to maintain the water at a predetermined temperature;
(c) placing the product to be dried on a second surface of the sheet, wherein the product comprises two or more items selected from the group consisting of foods, food extracts, herbs, herb extracts, vitamins, and supplements,
whereby a dried product is produced.

2. The method of claim 1, wherein one of the items comprising the product to be dried is derived from aloe.

3. A dried product produced by the method of claim 1,

4. The dried product of claim 3, wherein the ratio of the components in the product to be dried is retained throughout the dried product.

5. A composition comprising dried aloe and at least one items selected from the group consisting of foods, food extracts, herbs, herb extracts, vitamins, and supplements, wherein the composition is homogeneous.

6. The composition of claim 5, wherein the homogeneity of the composition is retained for at least about three years.

7. The composition of claim 5, wherein the composition comprises aloe, tea or tea solids, ginseng, and Gingko.

8. The composition of claim 5, wherein the composition comprises aloe, blueberry, cranberry and raspberry.
